(19) United States
(12) Patent Application Publication
(10) Pub. No.: US 2023/0020447 A1
(43) Pub. Date: Jan. 19, 2023

(54) BATTERY MODULE AND METHOD FOR PRODUCING SUCH A BATTERY MODULE

(71) Applicant: Robert Bosch GmbH, Stuttgart (DE)

(72) Inventor: Markus Schmitt, Tamm (DE)

(21) Appl. No.: 17/861,295

(22) Filed: Jul. 11, 2022

(30) Foreign Application Priority Data
Jul. 13, 2021 (DE) 10 2021 207 408.1

(51) Int. Cl. H01M 50/103; H01M 50/171

(52) U.S. Cl. CPC H01M 50/103; H01M 50/171

(57) ABSTRACT

A battery module having a plurality of prismatic battery cells, in particular lithium-ion battery cells, which are arranged next to one another in a longitudinal direction of the battery module, wherein the plurality of battery cells are received in an interior of a housing of the battery module and additionally a bottom surface of the housing of the battery module and a bottom surface of the battery cells are respectively cohesively connected to one another, in particular in an adhesively bonded manner by means of an adhesive, wherein a compressing element is arranged between the housing and the plurality of battery cells in the longitudinal direction of the battery module, so that a defined spacing is formed for electrical insulation from the housing.

### BACKGROUND

The invention relates to a battery module. The present invention also relates to a method for producing such a battery module.

It is known from the prior art that a battery module has a plurality of individual battery cells which each have a positive voltage tap and a negative voltage tap, wherein, for the purpose of electrically conductively connecting the plurality of battery cells to one another in series and/or in parallel, the respective voltage taps are electrically conductively connected to one another and therefore can be interconnected to form the battery module. Battery modules, for their part, are further interconnected to form batteries or to form entire battery systems.

In particular, lithium-ion battery cells or lithium-polymer battery cells heat up as a result of chemical conversion processes in their interior, particularly in the case of rapid energy release or absorption in battery systems. The more powerful the battery system, the more it is heated up and consequently an efficient active thermal management system is required.

Temperature control is primarily in the form of liquid temperature control, for example using a water/glycol mixture. The temperature-control fluid is conducted, for example, through ducts in a cooling element arranged below the battery cells. In addition, these cooling elements are connected to a cooling circuit.

In addition, it is known from the prior art in this respect to remove heat from the battery cells via their cell bottoms, wherein the flow of heat passes through the bottom of the cell housing and a cooling plate into the cooling medium. Thermal contact-connection between the cell bottom and the cooling element is implemented by means of what is known as a thermal interface material (TIM), this possibly being, for example, a thermally conductive adhesive, what is known as a gap filler or what is known as a gap pad.

Prior art documents in this respect include, for example, US 2014/0087231, EP 3 694 036, KR 100 739 841, US 2017/0170510 or JP 2016/0085895.

### SUMMARY

A battery module offers the advantage that reliable electrical insulation of a plurality of battery cells over the service life thereof is provided by the housing of the battery module overall.

According to the invention, a battery module having a plurality of prismatic battery cells, which are in the form of lithium-ion battery cells in particular, is provided for this purpose. Here, the battery cells are arranged next to one another in a longitudinal direction of the battery module. Furthermore, the plurality of battery cells are received in an interior of a housing of the battery module. In addition, a bottom surface of the housing of the battery module and a bottom surface of the battery cells are respectively cohesively connected to one another. In particular, this connection is formed in an adhesively bonded manner by means of an adhesive which can preferably contain thermally conductive additives. A compressing element and/or a supporting element is arranged between the housing of the battery module and the plurality of battery cells in the longitudinal direction of the battery module, so that a defined spacing is formed for electrical insulation from the housing.

Advantageous developments of and improvements to the apparatus specified in the independent claim are possible owing to the measures set out in the dependent claims.

At this point, it should be noted that prismatic battery cells each comprise a battery cell housing with a total of six side surfaces, pairs of which are arranged opposite and substantially parallel to one another. Furthermore, side surfaces arranged adjacent to one another are arranged at a right angle to one another. The electrochemical components of the respective battery cell are received in an interior of the battery cell housing. Usually, two voltage taps, such as a positive voltage tap and a negative voltage tap in particular, are arranged on an upper side surface, referred to as the top surface. The lower side surface arranged opposite the upper side surface is referred to as the bottom surface.

In the case of arrangement of the battery cells next to one another in a longitudinal direction of the battery module, the battery cells are arranged adjacent to one another by way of their respectively largest side surfaces, which are each arranged in particular a right angle to the upper side surface and the lower side surface. At this point, it should be noted that the longitudinal direction of the battery module is accordingly arranged perpendicularly to the largest side surfaces of the battery cells in this case.

At this point, it should be noted that, in order to form a cohesive connection formed in an adhesively bonded manner between the bottom surface of the housing of the battery module and the bottom surface of the battery cells by means of an adhesive, either preferably initially the adhesive can be dispensed into the housing of the battery module or onto the bottom surface of the housing of the battery module and/or the adhesive can also be dispensed onto the respective battery cell. Here, the cohesive connection formed in an adhesively bonded manner serves firstly to improve the conduction of heat between the bottom surface of the battery cell and the bottom surface of the housing and secondly for mechanical load transfer and in particular also for electrical insulation.

It is expedient when the compressing element tapers here perpendicularly to the longitudinal direction of the battery module in the direction of the bottom surface of the housing of the battery module. In particular, the compressing element has two contact surfaces. Here, a first of the two contact surfaces is arranged, in particular, so as to make mechanical contact with the housing of the battery module, and a second of the two contact surfaces is arranged here, in particular, so as to make mechanical contact with a battery cell, arranged at an end, of the plurality of battery cells or an end plate described further below. Here, the two contact surfaces are arranged at an angle of at least four degrees with respect to one another. Here, the contact surfaces are furthermore designed, in particular, with such dimensions that thermal decoupling between the housing and the plurality of battery cells is ensured. In particular, the contact surfaces should be designed here with such a size that, at the beginning of the service life, reliable contact and positioning of the plurality of battery cells in the housing of the battery module are achieved until the thermally conductive adhesive cures, and that swelling forces, which are produced at the end of the service life, of the plurality of battery cells can be reliably transferred to the housing of the battery module, without the compressing element itself being mechanically damaged. Furthermore, the compressing element serves to compensate for both tolerances of the housing and of the plurality of battery cells. In order to ensure this, the compressing element is inserted in the vertical direction of the battery module in the direction of the bottom surface of the housing of the battery module, in particular until defined compression of the plurality of battery cells is formed.

It is advantageous when the compressing element is received in a form-fitting manner in a receptacle of the housing of the battery module. As a result, reliable fastening of the compressing element can be formed. In particular, the receptacle forms an angle of at least four degrees with respect to a vertical direction of the battery module arranged perpendicularly to the longitudinal direction. As a result, the process of receiving the compressing element can be simplified. At this point, it should be noted that the receptacle forms a further contact surface on which, in particular, the first of the two contact surfaces of the compressing element is arranged so as to make mechanical contact. In particular, even this contact surface forms the angle of at least four degrees with respect to the vertical direction of the battery module arranged perpendicularly to the longitudinal direction. The compressing element is particularly preferably arranged so as to make linear contact with the housing or the receptacle of the housing.

At this point, it should be noted that the housing of the battery module is preferably designed in the form of a die-cast component, for example from a metal material. Furthermore, in particular, the interior of the housing can be electrically insulating. The housing can preferably have an electrically insulating coating, such as a cathodic electrodeposition coating or an Eloxal for example. In particular, the electrically insulating coating can also be in the form of an electrically insulating film. Furthermore, the, in particular thermally conductive, adhesive arranged between the bottom surface of the housing and the bottom surface of the plurality of battery cells can also additionally be electrically insulating. In particular, such an adhesive could here form a thermal and mechanical connection between the bottom surface of the housing and the bottom surface of the plurality of battery cells, the connection additionally being electrically insulating. For this purpose, an electrically non-conductive compensation material, such as preferably a thermally conductive adhesive or an electrically insulating structural adhesive, can be used, for example for thermal and/or mechanical connection of the plurality of battery cells to the interior of the housing. As a result, electrical insulation between the bottom surface of the housing and the bottom surface of the plurality of battery cells can be formed over the service life.

According to a preferred embodiment of the invention, a supporting element is arranged opposite the compressing element in the longitudinal direction of the battery module. Here, the supporting element is arranged between the housing of the battery module and the plurality of battery cells. In particular, the supporting element is arranged between the housing and a battery cell, arranged at an end, of the plurality of battery cells or an end plate, yet to be described below.

The supporting element preferably has an opening and contact surfaces. In particular, the supporting element has first contact surfaces, which are formed to make mechanical contact with the housing of the battery module, and second contact surfaces, which are formed to make mechanical contact with a battery cell, arranged at an end, of the plurality of battery cells or an end plate yet to be described below. Owing to the design with an opening, comparably small contact surfaces can be formed for establishing mechanical contact between the battery cell arranged at an end or the end plate yet to be described and the housing, as a result of which thermal decoupling is ensured. In particular, the contact surfaces should be designed with such a size that, at the beginning of the service life, reliable contact and positioning of the plurality of battery cells in the housing of the battery module are achieved until the thermally conductive adhesive cures, and that swelling forces, which are produced at the end of the service life, of the plurality of battery cells can be reliably transferred to the housing of the battery module, without the compressing element itself being mechanically damaged. The supporting element is particularly preferably formed from a polymeric material, such as in the form of a plastic injection-molded part for example.

At this point, it should additionally be noted that the supporting element is designed in such a way that tolerances between the housing of the battery module and the plurality of battery cells can be reliably compensated for.

It is particularly expedient when the battery module has two compressing elements. Here, the two compressing elements are arranged at the same end of the plurality of battery cells. This offers the particular advantage that even better compensation is possible, wherein the two compressing elements can be reliably arranged in particular independently of one another and in each case autonomously. For example, the two compressing elements can be inserted to different extents. In addition, swelling forces, which are produced as a result, of the battery cells can be uniformly transferred to the housing of the battery module via the two compressing elements, as a result of which reaction forces which are produced in different ways on one side can be avoided.

Furthermore, it is also expedient when the housing of the battery module comprises a temperature-control element directly adjacent to the bottom surface of the battery cells. In particular, said temperature-control element is in the form of a temperature-control chamber through which temperature-control fluid can flow. For example, the housing of the battery module can have an integrated temperature-control chamber for this purpose. In a preferred embodiment, the plurality of battery cells is thermally conductively connected to the bottom surface of the housing in particular by means of a thermally conductive adhesive, as a result of which heat can be transferred from the bottom surface of the respective battery cell to the temperature-control element. The thermally conductive adhesive therefore serves to establish thermal contact between the temperature-control element and the plurality of battery cells.

Furthermore, the plurality of battery cells are particularly preferably braced with one another.

The plurality of battery cells are preferably arranged between two end plates in this case. At this point, it should be noted that the battery cells arranged opposite in the longitudinal direction of the battery module and at an end are respectively arranged adjacent to one of the two end plates. The two end plates are braced with one another by means of at least one clamping element. In particular, the clamping element is in the form of a clamping band. Here, the at least one clamping element is preferably cohesively connected to the end plates. For example, this connection can preferably be formed in a welded manner. The battery module particularly preferably comprises two clamping elements which are each preferably in the form of a clamping band and/or which are arranged opposite one another on the plurality of battery cells, wherein a first end of the respective clamping element is respectively connected to a first of the two end plates and a second end of the respective clamping element is respectively connected to a second of the two end plates. Here, these connections are preferably formed in a cohesive manner, such as in particular in a welded manner. A cohesive connection between the at least one clamping element and the end plates can advantageously transfer comparably high forces. At this point, it should be noted that a comparably low initial pre-stressing force can be formed by the compressing element owing to the pre-stressing or pre-pressing of the plurality of battery cells formed by means of the clamping element at the beginning of the service life.

An adhesive is particularly preferably arranged between a side surface of a battery cell and the clamping element. Here, the adhesive can furthermore have thermally conductive additives. Therefore, a situation where the adhesive is in the form of a thermally conductive adhesive is particularly preferred. In particular, said adhesive can be selected to be the same adhesive as that which forms a cohesive connection between the bottom surface of the housing of the battery module and the bottom surface of the battery cell. At this point, it should be noted that here the side surface of the battery cell is in each case arranged perpendicularly to the largest side surfaces of the battery cell. For production purposes, here, the adhesive can initially be applied either to the respective side surface of the battery cell or else to the clamping element. The connection formed in an adhesively bonded manner between a side surface of a battery cell and the clamping element contributes, overall, to the adhesive connection between the bottom surface of the housing of the battery module and the bottom surface of a battery cell being subject to lower loads during operation of the battery module.

It is expedient when the clamping element is electrically insulated from the plurality of battery cells. In particular, the clamping element can be formed, in principle, from a metal material. The clamping element can preferably have an electrically insulating coating, such as a cathodic electrodeposition coating or an Eloxal for example. In particular, the electrically insulating coating can also be in the form of an electrically insulating film. Furthermore, the, in particular thermally conductive, adhesive arranged between the clamping element and the plurality of battery cells can also additionally be electrically insulating. In particular, such an adhesive could here form a thermal and mechanical connection between the clamping element and the plurality of battery cells, the connection additionally being electrically insulating.

At this point, it should be noted that the end plates are also electrically insulated from the plurality of battery cells. In particular, the end plates can be formed, in principle, from a metal material. The end plates can preferably have an electrically insulating coating, such as a cathodic electrodeposition coating or an Eloxal for example. In particular, the electrically insulating coating can also be in the form of an electrically insulating film. Furthermore, the, in particular thermally conductive, adhesive arranged between the end plate and the plurality of battery cells can also additionally be electrically insulating. In particular, such an adhesive could here form a thermal and mechanical connection between an end plate and the plurality of battery cells, the connection additionally being electrically insulating.

In particular, the clamping element and an end plate are cohesively connected to one another, as a result of which an electrically conductive connection is formed in addition to a thermal coupling, and therefore electrical insulation of an end plate can reliably considerably increase the safety.

The supporting element is advantageously connected in a form-fitting or cohesive manner to an end plate or to the housing. This allows comparably simple production of the battery module.

The compressing element and/or the supporting element are/is particularly preferably formed from a polymeric material, such as in the form of a plastic injection-molded part for example.

A respective spacer element is preferably arranged between two battery cells arranged adjacent to one another, which spacer elements provide electrical insulation between the two battery cells arranged adjacent to one another. In particular, the spacer element of this kind is accordingly arranged adjacent to the respectively largest side surfaces of the battery cells, between which the spacer element is arranged. Spacer elements of this kind can in particular prevent direct contact between the battery cells respectively arranged adjacent to one another and therefore form a defined spacing between the battery cells of this kind. As a result, thermal insulation and/or electrical insulation can be formed.

Furthermore, a spacer element is in particular also arranged between a battery cell arranged at an end and an end plate, which spacer element provides electrical insulation between the battery cell arranged at an end and the end plate. Furthermore, it is also possible for a thermal compensation material, which is electrically insulating, to be able to be arranged between an end plate and a battery cell arranged at an end.

At this point, it should be noted that a spacer element can be formed from an electrically non-conductive material for this purpose. Furthermore, it is also possible for a spacer element, formed from a metal material for example, to have an electrically insulating coating, such as an electrically insulating insulation film for example. It goes without saying that these designs can also be combined with one another.

Overall, an embodiment according to the invention of the battery module offers the advantage that the compressing element, in particular its two contact surfaces, makes/make mechanical contact with the housing and the plurality of battery cells or the respective end plate and that, opposite to this, the supporting element, in particular its two contact surfaces, makes/make mechanical contact with the housing and the plurality of battery cells or the respective end plate, as a result of which positioning and fixing of the plurality of battery cells in the housing is ensured both at the beginning of the service life (BoL for short) and at the end of the service life (EoL for short).

In particular, the compressing element and the supporting element exert comparably lower pre-stressing forces on the plurality of battery cells at the beginning of the service life. During operation of the battery module, the swelling forces of the battery cells increase comparably sharply from the beginning of the service life to the end of the service life. In particular, the stresses within the cohesive connection between the battery cells arranged at an end and the housing increase comparably sharply. In order to reduce and thereby to limit stresses occurring within the cohesive connection, such as in particular within the connection formed in an adhesively bonded manner, between the bottom surface of the housing of the battery module and the bottom surface of the battery cells and also between the clamping element and the side surfaces of the battery cells, the compressing element and the supporting element are supported on the housing. As a result, overall, the mechanical load within the cohesive connection is reduced, in particular at the end of the service life, and failure of said cohesive connection is prevented, as a result of which the reliability of the battery module can be increased overall. In addition, the risk of adequate temperature control of the battery cells no longer being provided on account of failure of the cohesive connection can preferably be considerably reduced. Furthermore, as a result, the properties of the adhesive, such as its strength up to elongation at break for example, can be selected in a comparably larger range as a result. For example, a thermally conductive adhesive with relatively low strength values and better thermal conductivity could be selected. Overall, reliable electrical insulation is provided as a result.

In particular, the compressing element is arranged so as to make mechanical contact with the housing in such a way that a spacing is always formed between the housing and the end plate or the battery cell at an end. As a result, an air gap with a thermally insulating action is formed.

It should further also be noted that both the compressing element and the supporting element could also be formed from a metal material, as a result of which even higher forces would be able to be transferred in particular. In this case, thermal insulation and/or electrical insulation should be provided in order to thermally and/or electrically insulate the plurality of battery cells from the housing of the battery module.

Here, an embodiment according to the invention of the battery module provides the particular advantage that the plurality of battery cells are spaced apart from the housing of the battery module both in the longitudinal direction and also in the transverse direction, in particular during assembly, and reliable electrical insulation is provided, in particular until the thermally conductive adhesive has cured. Here, the spacings can also be set such that in particular the requirements in respect of clearance and creepage distances can be complied with over the entire service life of the battery module. After, for example, the thermally conductive adhesive between the bottom surface of the battery cells and the bottom surface of the housing of the battery module has cured, relative movements between the plurality of battery cells and the housing are not possible, and therefore positioning of the plurality of battery cells can be securely and reliably set as early as during assembly. The compressing element and the supporting element can set the required distances here.

Furthermore, reliable electrical insulation can be provided even when there are faults in the insulation, for example of the housing, of the end plates, of the clamping element or of the plurality of battery cells.

In particular, the risk of electrical contact-connection between the plurality of battery cells, the clamping element and also the end plates and the housing, for example when metal particles appear, for example when cohesively fitting cell connectors to form an electrically conductive connection between the voltage taps of the plurality of battery cells, can be prevented. Here, the spacings formed can be set such that electrical contact-connection can be precluded up to a defined particle size.

Owing to the necessary distances between the end plates, the clamping elements and also the plurality of battery cells from the housing of the battery module being complied with, friction between the plates, the clamping elements, the plurality of battery cells and the housing of the battery module can moreover also be prevented when slight relative movements occur. Such rubbing could damage the electrical insulation, as a result of which insulation faults could occur.

The present invention also relates to a method for producing a battery module as just described comprising a plurality of prismatic battery cells which are in particular in the form of lithium-ion battery cells and which are arranged next to one another in a longitudinal direction of the battery module and are furthermore preferably braced with one another. Here, the plurality of battery cells are received in an interior of a housing of the battery module and additionally a bottom surface of the housing of the battery module and a bottom surface of the battery cells are respectively cohesively connected to one another, in particular in an adhesively bonded manner by means of an adhesive. Furthermore, a compressing element and/or a supporting element is arranged between the housing and the plurality of battery cells in the longitudinal direction of the battery module.

It is particularly preferred here when the plurality of battery cells are braced with one another, and in particular are arranged between two end plates, which are braced with one another by way of a clamping element in particular, as a result of which initial compression or pre-stressing can be formed at the beginning.

Furthermore, a supporting element is preferably arranged opposite the compressing element in the longitudinal direction of the plurality of battery cells.

It is expedient when, for producing the battery module, the plurality of battery cells braced with one another are pushed, in particular together with the spacer elements arranged between adj acent battery cells, the two end plates and the at least one clamping element as an entire unit, in the direction of the supporting element until said supporting element makes contact with the housing and also before, for example, the thermally conductive adhesive cures. In other words, said elements or the entire unit are/is displaced on the adhesive. The compressing element is then inserted into the battery module until defined compression is formed. In particular, in this case, the compressing element can already be pre-fixed to the cell stack or else fixed only after the compressing element has been finally inserted. Owing to the arrangement of the compressing element, tolerances in the arrangement of the plurality of battery cells and/or the housing can be compensated for in this case.

### BRIEF DESCRIPTION OF THE DRAWINGS

Exemplary embodiments of the invention are illustrated in the drawings and described in greater detail in the following description.

In the drawings:

FIG. 1 shows an exploded illustration of a plurality of battery cells braced with one another,

FIG. 2 shows a perspective view of the plurality of battery cells braced with one another in accordance with FIG. 1,

FIG. 3 shows a sectional view of an embodiment of a battery module according to the invention from one side,

FIG. 4 shows a sectional view of the embodiment of the battery module according to the invention in accordance with FIG. 3 from another side,

FIG. 5 shows an embodiment of a supporting element,

FIG. 6 shows an embodiment of a compressing element, and

FIG. 7 shows an embodiment of a housing of the battery module.

### DETAILED DESCRIPTION

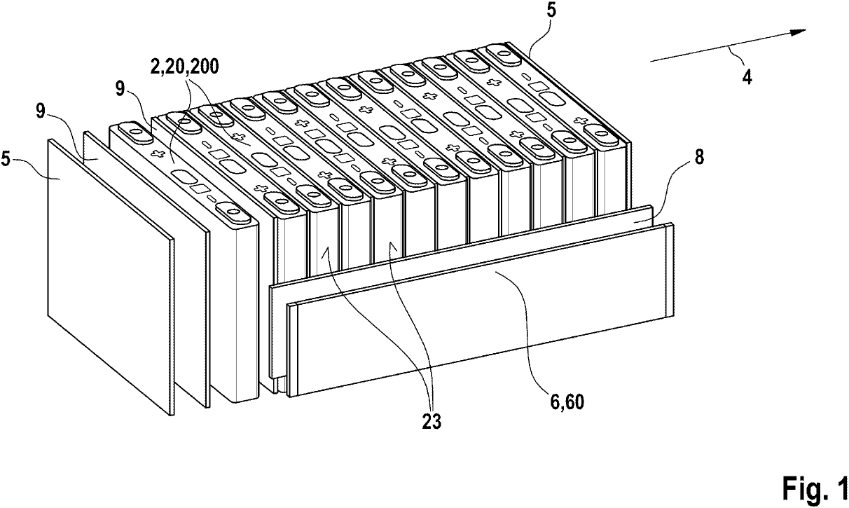

FIG. 1 shows an exploded illustration of a plurality of battery cells 2, braced with one another, which are each in the form of prismatic battery cells 20. In particular, the battery cells 2 are preferably in the form of lithium-ion battery cells 200.

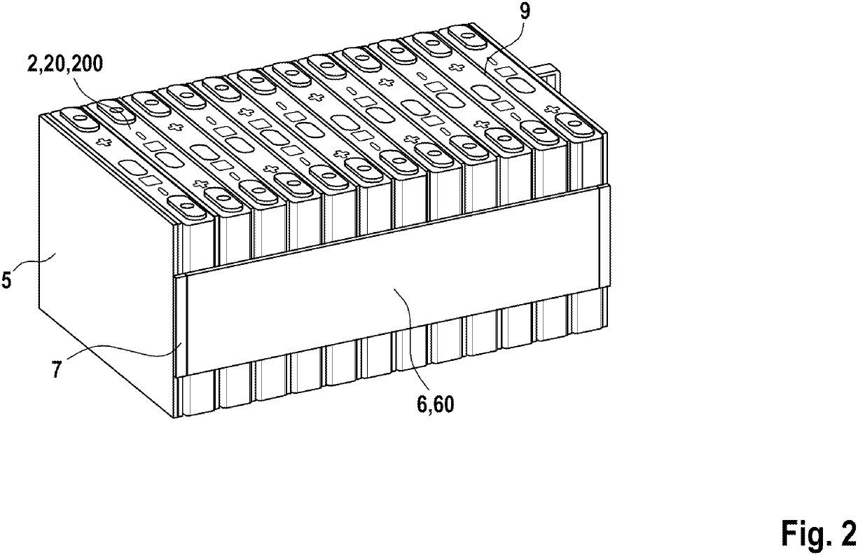

FIG. 2 shows a perspective view of the plurality of battery cells 2, braced with one another, in accordance with FIG. 1. Therefore, FIGS. 1 and 2 should be described together in the text which follows.

In said figures, the battery cells 2 are arranged next to one another in a longitudinal direction 4 of the battery module 1. In addition, the battery cells 2 are braced with one another.

Furthermore, said figure shows that the plurality of battery cells 2 are arranged between two end plates 5. Here, the two end plates 5 and the plurality of battery cells 2 are braced with one another by way of clamping elements 6. In particular, the clamping elements 6 are each in the form of a clamping band 60 here. In particular, FIG. 2 shows that the clamping element 6 is cohesively connected to the end plates 5, such as in particular in a welded manner by means of a welded connection 7.

An adhesive 8, which particularly preferably has thermally conductive additives, is arranged between the clamping element 6 and a side surface 23 of a battery cell 2. Furthermore, the clamping element 6 is electrically insulated from the plurality of battery cells 2.

In addition, a respective spacer element 9 is arranged between two battery cells 2 arranged adj acent to one another, which spacer elements provide electrical insulation between the two battery cells 2 arranged adjacent to one another. A spacer element 9 is also arranged between an end plate 5 and a battery cell 2 arranged at an end, which spacer element provides electrical insulation between the battery cell 2 arranged at an end and the end plate 5.

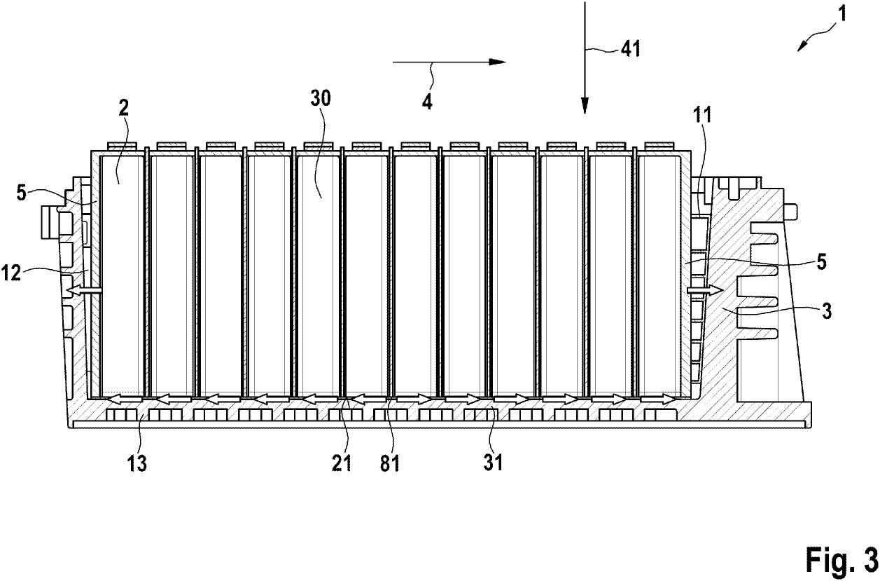

FIG. 3 shows a sectional view of an embodiment of a battery module 1 according to the invention from one side.

Said figure shows that the plurality of battery cells 2 are received in an interior 30 of a housing 3 of the battery module 1.

Furthermore, a bottom surface 31 of the housing 3 of the battery module 1 and a bottom surface 21 of the battery cells 2 are respectively cohesively connected to one another. In particular, this connection can be formed by means of an adhesive 81.

Here, the housing 3 of the battery module 1 comprises a temperature-control element 13 directly adjacent to the bottom surfaces 21 of the battery cells 2.

A compressing element 11 is arranged between the housing 3 of the battery module 1 and the plurality of battery cells 2 in the longitudinal direction 4 of the battery module 1. Here, the compressing element 11 tapers perpendicularly to the longitudinal direction 4 of the battery module 1 in the direction of the bottom surface 31 of the housing 3 of the battery module 1. In particular, this taper is formed in a vertical direction 41, which is arranged perpendicularly to the longitudinal direction 4.

Furthermore, said figure shows that a supporting element 12 is arranged between the housing 3 of the battery module 1 and the plurality of battery cells 2 opposite the compressing element 11 in the longitudinal direction 4 of the battery module 1.

Furthermore, FIG. 3 shows the above-described primary mechanical load path, in which a mechanical load is transferred from the plurality of battery cells 2 to the bottom surface 31 of the housing 3 of the battery module 1 via the cohesive connection at the bottom of the housing 3 of the battery module 1 during operation. Furthermore, a force is transferred to the housing 3 of the battery module 1 via the supporting element 12 and the compressing element 11.

As a result, a defined spacing, in particular between an end plate 5 and the housing 3, is formed for electrical insulation.

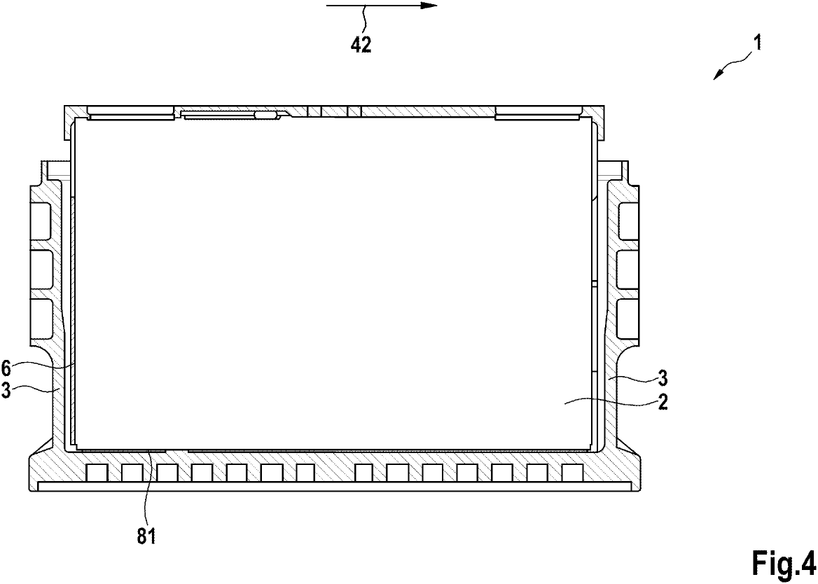

FIG. 4 shows a sectional view of the embodiment of the battery module 1 according to the invention in accordance with FIG. 3 from another side.

Said figure shows the clamping element 6, the housing 3, the adhesive 81 and a battery cell 2. Furthermore, a transverse direction 42 is shown, which is arranged perpendicularly to the longitudinal direction 4 and the vertical direction 41.

Here, a defined spacing is also formed between the housing 3 and the battery cell 2.

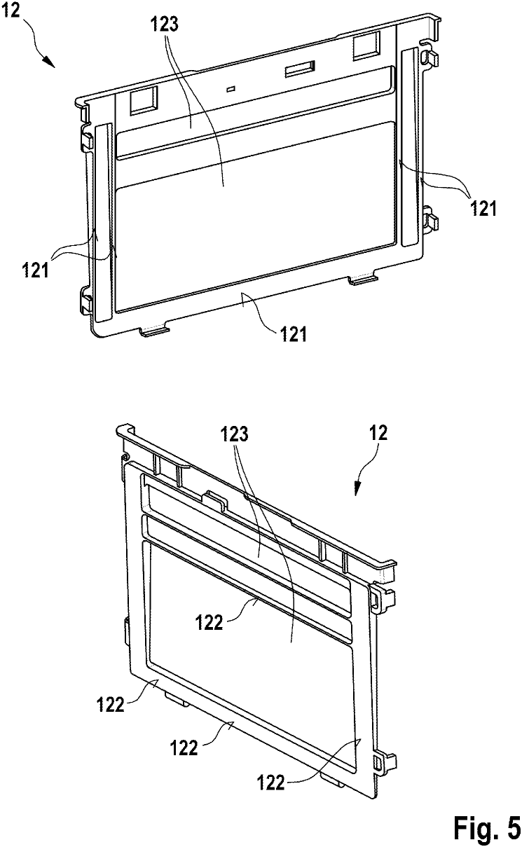

FIG. 5 shows an embodiment of a supporting element 12.

The left-hand-side illustration in said figure shows a first view with contact surfaces 121, which are formed to make mechanical contact with the end plates 5. Furthermore, the right-hand-side illustration shows a second view with contact surfaces 122, which are formed to make mechanical contact with the housing 3 of the battery module 1.

Furthermore, the supporting element 12 has an opening 123. Said opening 123 serves to ensure thermal decoupling.

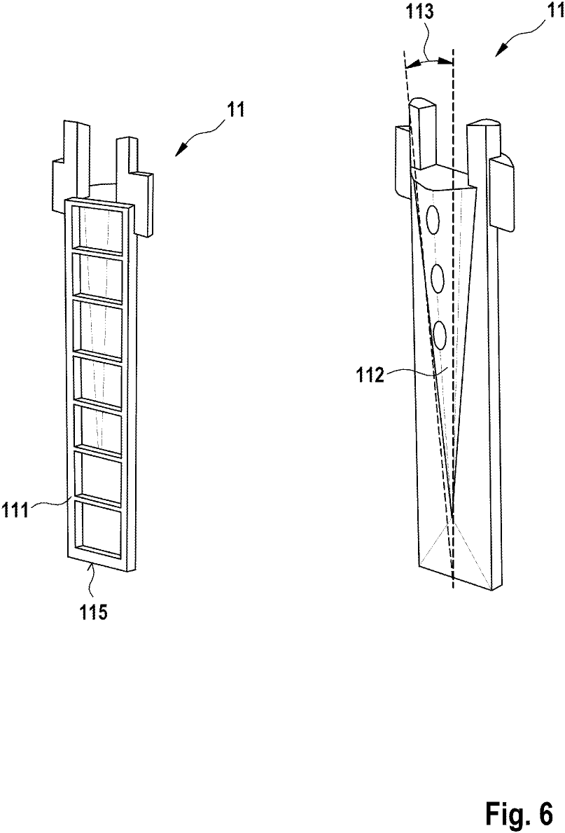

FIG. 6 shows an embodiment of a compressing element 11.

The left-hand-side illustration of said figure shows a first view with a first contact surface 111 which is formed to make mechanical contact with the end plates 5. Furthermore, the right-hand side illustration shows a second view with a second contact surface 112 which is formed to make mechanical contact with the housing 3 of the battery module 1. In particular, the second contact surface 112 is in the form of a linear contact here.

Said figure shows that the first contact surface 111 and the second contact surface 112 are arranged at an angle 113 with respect to one another, wherein the angle has, in particular, a value of at least four degrees.

Such a compressing element 11 is particularly preferably formed from a polymeric material.

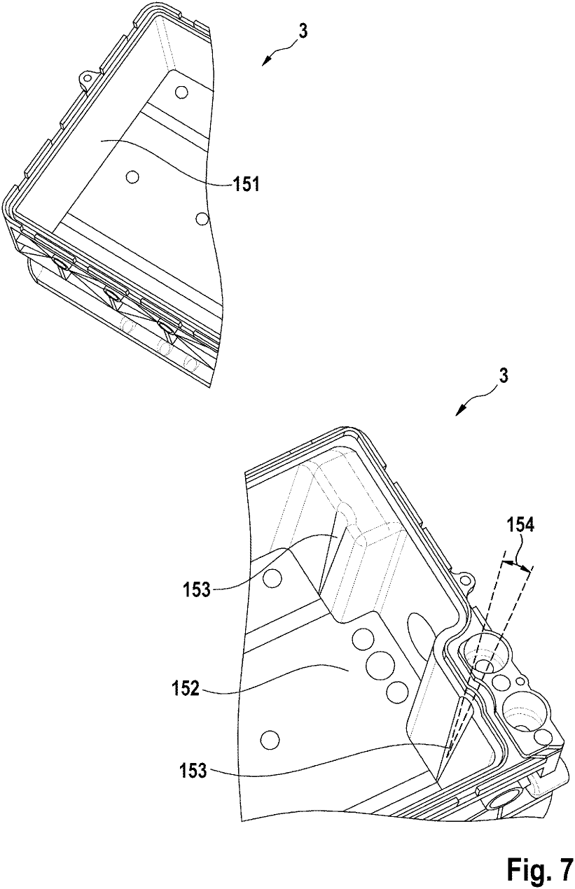

FIG. 7 shows an embodiment of a housing 3 of the battery module 1.

The left-hand-side illustration in said figure shows the inner side 151 of the housing 3 of the battery module 1, on which inner side the supporting element 12 is arranged.

The right-hand-side illustration in said figure shows the inner side 152 of the housing 3 of the battery module 1, on which inner side the compressing element 11 is arranged or the compressing elements 11 are arranged.

Said figure shows that the housing 3 of the battery module 1 comprises receptacles 153 in which a respective compressing element 11 can be received in a form-fitting manner. In particular, the receptacles 153 in this case are in the form of guide grooves in which the linear contact of the compressing element 11 can preferably be received. That is to say, linear or in other words very narrow contact is formed between the receptacle 153 and the compressing element 11.

Furthermore, a receptacle 153 can also form an angle 154 which is formed with respect to a vertical direction 41 of the battery module 1 arranged perpendicularly to the longitudinal direction 4 of the battery module 1 and has a value of at least four degrees.

1. A battery module having a plurality of prismatic battery cells (2, 20) that are arranged next to one another in a longitudinal direction (4) of the battery module (1), wherein the plurality of battery cells (2) are received in an interior (30) of a housing (3) of the battery module (1) and additionally a bottom surface (31) of the housing (3) of the battery module (1) and a bottom surface (21) of the battery cells (2) are respectively cohesively connected to one another, wherein a compressing element (11) and/or a supporting element (12) is arranged between the housing (3) and the plurality of battery cells (2) in the longitudinal direction (4) of the battery module (1), so that a defined spacing is formed for electrical insulation from the housing (3).

2. The battery module according to claim 1, wherein the compressing element (11) tapers perpendicularly to the longitudinal direction (4) of the battery module (1) in a direction of the bottom surface (31) of the housing (3) and has two contact surfaces (111, 112) which are arranged at an angle (113) of at least four degrees with respect to one another.

3. The battery module according to claim 1, wherein the compressing element (11) is received in a form-fitting manner in a receptacle (153) of the housing (3) of the battery module (1), wherein the receptacle (153) forms an angle (154) of at least four degrees with respect to a vertical direction (41) of the battery module (1) arranged perpendicularly to the longitudinal direction (4).

4. The battery module according to claim 1, wherein a supporting element (12) is arranged between the housing (3) of the battery module (1) and the plurality of battery cells (2) opposite the compressing element (11) in the longitudinal direction (4) of the battery module (1).

5. The battery module according to claim 4, wherein the supporting element (12) comprises an opening (123) and contact surfaces (121, 122).

6. The battery module according to claim 1, wherein the battery module (1) has two compressing elements (11).

7. The battery module according to claim 1, wherein the housing (3) comprises a temperature-control element (13) directly adjacent to the bottom surfaces (21) of the battery cells (2), which temperature-control element (13) is in the form of a temperature-control chamber through which temperature-control fluid can flow.

8. The battery module according to claim 1, wherein the plurality of battery cells (2) are braced with one another.

9. The battery module according to claim 8, wherein the plurality of battery cells (2) are arranged between two end plates (5) which are braced with one another by way of at least one clamping element (6).

10. The battery module according to claim 9, wherein an adhesive (8) is arranged between a side surface (23) of a battery cell (2) and the clamping element (6).

11. The battery module according to claim 9, wherein the clamping element (6) is electrically insulated from the plurality of battery cells (2).

12. The battery module according to claim 4, wherein the supporting element (12) is connected in a form-fitting or cohesive manner to an end plate (5) or to the housing (3).

13. The battery module according to claim 1, wherein the compressing element (11) and/or the supporting element (12) is formed from a polymeric material.

14. The battery module according to claim 1, wherein a respective spacer element (9) is arranged between two battery cells (2) arranged adjacent to one another, which spacer elements provide electrical insulation between the two battery cells (2) arranged adjacent to one another and furthermore a spacer element (9) is arranged between a battery cell (2) arranged at an end and an end plate (5), which spacer element provides electrical insulation between the battery cell (2) arranged at an end and the end plate (5).

15. A method for producing a battery module according to claim 1.

16. The method according to claim 15, wherein the plurality of battery cells (2) braced with one another are pushed in a direction of a supporting element (12) arranged between the housing (3) and the plurality of battery cells (2) and also opposite the compressing element (11) on the plurality of battery cells (2) until the supporting element (12) makes contact with the housing (3) and then the compressing element (11) is inserted until a defined compression is formed.

17. The battery module according to claim 1, wherein the plurality of battery cells are lithium-ion battery cells (200).

18. The batter module according to claim 1, wherein the bottom surface (31) of the housing (3) of the battery module (1) and the bottom surface (21) of the battery cells (2) are respectively cohesively connected to one another in an adhesively bonded manner by adhesive.

19. The battery module according to claim 9, wherein the at least one clamping element (6) is a clamping band (60), and the at least one clamping band (60) is cohesively connected to the end plates (5) in a welded manner.

20. The battery module according to claim 10, wherein the adhesive (8) has thermally conductive additives.
